(19) United States
(12) Patent Application Publication
(10) Pub. No.: US 2002/0128571 A1
(43) Pub. Date: Sep. 12, 2002

(54) Method and apparatus for intercostal cardiac compression device

(76) Inventor: Rodney A. Brenneman, San Juan Capistrano, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/801,421

(22) Filed: Mar. 7, 2001

(51) Int. Cl. A61H 31/00

(52) U.S. Cl. 601/41

(57) ABSTRACT

The present invention provides improved devices and methods for performing cardiac massage, particularly minimally invasive direct cardiac massage where the heart is directly compressed through a small incision formed through an intercostal space over the pericardium. Devices according to the present invention may comprise a support having a laterally oriented expansible structure, optionally carrying a sheet or inflatable bladder for engaging the pericardium. The laterally oriented expansible structure comprises a plurality of lateral extensions being collapsible to a generally L shaped configuration and expandable along a radial path to define a surface which non-traumatically engages a pericardium to compress the heart.

### BACKGROUND OF THE INVENTION

1. Field of the Invention

The present invention relates generally to medical devices and methods. More particularly, the present invention relates to devices and methods for performing minimally invasive direct cardiac massage.

Sudden cardiac arrest is a leading cause of death in most industrial societies. While in many cases it is theoretically possible to re-establish cardiac function, irreversible damage to vital organs, particularly the brain and the heart itself, will usually occur prior to restoration of normal cardiac activity.

A number of techniques have been developed to provide artificial circulation of blood to oxygenate the heart and brain during the period between cardiac arrest and restoration of normal cardiac activity. Prior to the 1960's, open chest cardiac massage (OCM) was a standard treatment for sudden cardiac arrest. Open chest cardiac massage, as its name implies, involved opening a patient's chest and manually squeezing the heart to pump blood to the body. In the 1960's, closed chest cardiac massage (CCM) where the heart is externally compressed through the chest wall became the standard of treatment. When CCM is combined with airway support, it is known as cardiopulmonary resuscitation (CPR). CPR has the advantage that it is much less invasive than OCM and can be performed by less skilled individuals. It has the disadvantage, however, that it is not generally effective. In particular, the medical literature shows that CCM provides significantly less cardiac output, neuroperfusion, and cardiac perfusion than achieved with OCM.

Of particular interest to the present invention is the recent introduction of devices for performing minimally invasive direct cardiac massage. Methods and devices for performing minimally invasive direct cardiac massage have been described by Buckman et al. and by Drs. Filiberto and Giorgio Zadini in the patent and literature publications listed in the Description of the Background Art below. Devices and methods extending the work of the Zadinis and Buckman et al. are also described by Brenneman et al. in co-pending application Ser. Nos. 09/087,665 filed May 29, 1998; 60/111,934 filed Dec. 11, 1998 (now abandoned); 09/344,440 filed Jun. 25, 1999; and 09/356,064 filed Jul. 19, 1999, assigned to the assignee of the present application.

While the methods of Buckman et al. and the Zadinis differ in a number of respects, they generally rely on introducing a balloon, shoe, cup, or other deployable member to engage the heart through a small incision through an intercostal space above the pericardium. The heart may then be pumped by directly engaging and compressing the pericardium, either by inflating and deflating the member or by reciprocating a shaft attached to the member. Although these approaches are effective, the particular devices described in the patents are not optimal for emergency use on human patients. In particular, the balloon-type and shoe-type heart-engaging members described in the patents may be difficult to deploy in the potential space between the posterior surface of the rib cage and the pericardium.

Alternatively, Brenneman et al. generally describes advancing a plurality of struts through an intercostal space to a region over a pericardium. The struts are opened along arcuate radially diverging paths between a posterior rib surface and the pericardium. The heart may then be pumped by directly engaging the opened struts against the pericardium to periodically compress the heart. While this improved strut-type design holds great promise, there may be circumstances where alternative structures would be advantageous.

For these reasons, it would be desirable to provide improved methods and devices for performing minimally invasive direct cardiac massage. In particular, it would be desirable to provide devices and methods which are simpler to deploy and expand in a shallow space between the posterior rib cage and the pericardium and which will better dissect adhesions between such a space. The heart-engaging component(s) of the devices should minimize risk to the pericardium from perforation and other damage while providing sufficient rigidity to compress the heart. The devices and methods should be simpler and less costly to manufacture and produce and impart an enhanced tactile feel to a user of the device. The apparatus and method should further be compatible both with manual actuation, i.e., manual reciprocation of a handle or shaft attached to the heart-engaging member, and with automatic or powered systems for reciprocating the handle. At least some of these objectives will be met by the invention described hereinafter.

2. Description of the Background Art

Devices and methods for minimally invasive direct cardiac massage through intercostal dissection are described co-pending application Ser. Nos. 09/087,665 filed May 29, 1998; 60/111,934 filed Dec. 11, 1998 (now abandoned); 09/344,440 filed Jun. 25, 1999; and 09/356,064 filed Jul. 19, 1999, assigned to the assignee of the present application. U.S. Pat. Nos. 5,582,580; 5,571,074 and 5,484,391 to Buckman, Jr. et al. and 5,683,364 and 5,466,221 to Zadini et al., licensed to the assignee of the present application, also describe devices and methods for minimally invasive direct cardiac massage through an intercostal space. Published PCT Application No. WO 98/05289 and U.S. Pat. No. 5,385,528 describe an inflatable device for performing direct cardiac massage. Devices and methods for establishing intercostal access are described in co-pending U.S. patent application Ser. No. 09/768,041 (Attorney Docket No. 018803-001700US), assigned to the assignee of the present application. U.S. Pat. No. 3,496,932 describes a sharpened stylet for introducing a cardiac massage device to a space between the sternum and the heart. Cardiac assist devices employing inflatable cuffs and other mechanisms are described in U.S. Pat. Nos. 5,256,132; 5,169,381; 4,731,076; 4,690,134; 4,536,893; 4,192,293; 4,048,990; 3,613,672; 3,455,298; and 2,826,193. Dissectors employing inflatable components are described in U.S. Pat. Nos. 5,730,756; 5,730,748; 5,716,325; 5,707,390; 5,702,417; 5,702,416; 5,694,951; 5,690,668; 5,685,826; 5,667,520; 5,667,479; 5,653,726; 5,624,381; 5,618,287; 5,607,443; 5,601,590; 5,601,589; 5,601,581; 5,593,418; 5,573,517; 5,540,711; 5,514,153; and 5,496,345. Use of a direct cardiac massage device of the type shown in the Buckman, Jr. et al. patents is described in Buckman et al. (1997) Resuscitation 34:247-253 and (1995) Resuscitation 29:237-248.

The full disclosures of each of the above references are incorporated herein by reference.

### SUMMARY OF THE INVENTION

The present invention provides improved devices and methods for performing cardiac massage, particularly minimally invasive direct cardiac massage where the heart is directly compressed through a small incision formed through an intercostal space over the pericardium. Devices according to the present invention may comprise a support, having a proximal end and a distal end, and a laterally oriented expansible structure attached to the distal end of the support. The laterally oriented expansible structure comprises a plurality of lateral extensions being collapsible to a generally L shaped configuration and expandable along a radial path to define a surface which non-traumatically engages a pericardium to compress the heart.

The support may be any assembly, structure, system, or other mechanical framework which is suitable for positioning and manipulating the laterally oriented expansible structure so that it can engage and compress the heart. Most simply, the support could be a simple handle or shaft having the laterally oriented expansible structure attached to the distal end thereof. Once the laterally oriented expansible structure is deployed, cardiac massage can be performed by simple manual pumping or reciprocation of the handle or shaft. In the exemplary embodiment described hereinafter, the support comprises at least two separate shafts. The shafts may be parallel and rotatably affixed relative to each other so that the lateral extensions can be expanded in a fan-like manner by counter rotating shafts, as described in more detail below. A wide variety of other supports will also be possible, including supports which comprise powered drivers, such as electric, pneumatic, or other motors. Such drivers can be provided as part of the support, where the driver may be disposed externally, internally, or both externally and internally relative to the patient when the laterally oriented expansible structure is deployed over the pericardium. Additionally, an indicator may be placed on the proximal end of the support or outside the patient for indicating the relative position of the lateral extensions.

The laterally oriented expansible structure generally comprises a plurality of lateral extensions, typically about 3 to 12 lateral extensions. The lateral extensions will be sufficiently rigid to compress the heart and to impart an enhanced tactile feel to a user of the cardiac massage device. The lateral extensions will typically be composed of metal, plastic, composite (e.g., epoxy, fiberglass), or like materials. Moreover, the laterally oriented expansible structure facilitates simple deployment and expansion in a relatively shallow space between the posterior rib cage and the pericardium. In particular, an important advantage of the present invention is that the fan-like expansion of the lateral extensions enhances adhesion dissection between the pericardium and the rib cage to allow for simple deployment in a shallow space.

The lateral extensions may be collapsed to a generally L shaped configuration which occupies less than one third of a of a fully expanded radial path of 360°. Typically, the lateral extensions will be collapsed during delivery of the laterally oriented expansible structure through an intercostal space to a region over a pericardium. Upon deployment, the lateral extensions may be expanded along a radial path of at least 90° to define a surface which engages the heart. Usually, the surface in a fully expanded radial path will be generally circular or slightly oval with a diameter or average diameter in the range from 3 cm to 10 cm. Alternatively, the laterally oriented expansible structure may form a non-symmetric surface, typically of three to four lateral extensions, which may be better oriented to minimize and/or avoid risk to the pericardium and/or to other intrathoracic organs. For example, a non-symmetric surface may be advantageous when a majority of the pericardium lies to one side of a cardiac massage entry site. Some of the lateral extensions may be curved or slightly concave to generally conform to an exterior surface of the pericardium and heart. Optionally, at least some of the lateral extensions may have conductive surfaces so as to allow for defibrillation, monitoring, pacing, and the like. The lateral extensions will have interlocking means, such as a lip, pin/slot, or like mechanism, with other lateral extensions for retracting and/or expanding the laterally oriented structure. Such interlocking means prevents over deployment and expansion of the lateral extensions.

In another embodiment of the present invention, the surface defined by the plurality of lateral extensions may comprise a flexible sheet attached to at least some of the lateral extensions. The sheet will usually, but not necessarily, be non-elastic or non-distensible, permitting it to readily conform to the surface of the pericardium as the lateral extensions are expanded. The sheet may be continuous, i.e., in the form of a continuous fabric, membrane, or the like, or may be discontinuous, i.e., in the form of a net, perforate sheet, permeable or impermeable sheet, or the like. Alternatively or additionally, an inflatable bladder may be attached to at least some of the lateral extensions. The inflatable bladder may comprise a generally flat structure extending over some or all of the lateral extensions. The bladder may be inflatable using a liquid or gas, preferably being inflatable with a physiologically acceptable liquid, such as saline, contrast medium, or the like.

In a still further embodiment of the present invention, a distal perimeter of the collapsed lateral extensions may act as a blunt dissecting member to permit intercostal penetration between adjacent ribs to a thoracic cavity over a heart so as to facilitate introduction of the device for direct cardiac compression. Alternatively, a cutting tip, such as a blade or trocar, coupled to the laterally oriented expansible structure or support may be adapted to penetrate percutaneously through intercostal tissue between adjacent ribs to a thoracic cavity over a heart. In this embodiment, the collapsed lateral extensions penetrate tissue, engage at least one rib, and stop advancement of the cutting tip into the thoracic cavity. As such, rapid sharp dissection with the cutting tip can be safely implemented without fear of blind advancement and/or accidentally puncturing intrathoracic organs.

In another aspect of the present invention, a cardiac compression device may comprise a handle and an expansible intercostal access structure laterally attached at a distal end of the handle. The structure comprises a tissue-dissecting tip and a preselected length to permit intercostal penetration, with the handle oriented to act as a stop to prevent penetration of an underlying heart. The handle and access structure are configured so that the handle may be raised to pass the access structure beneath the ribs to overlie the heart in a position to permit direct cardiac compression by reciprocating the handle. The tissue-dissecting tip may comprise a cutting means, such as a cutting tip, or a blunt dissecting means, such as a blunt member. The handle may comprise at least two separate shafts, each of which has a lateral extension. The shafts may be attached in a scissor-like manner so that the lateral extensions lie together when the shafts are apart and the lateral extensions spread apart as the shafts are drawn together.

In a still further aspect of the present invention, methods for performing cardiac massage are provided. One method comprises advancing an expansible structure comprising a plurality of lateral extensions through an intercostal space to a region over a pericardium. The structure will usually have a low profile configuration when introduced through the intercostal space and will be introduced with its “axis” on a generally posterior direction. After a distal tip of the expansible structure enters the region over the pericardium, the structure will be turned (optionally while the structure continues to be advanced), so that the structure eventually lies with its axis generally flat or parallel over the pericardium anterior the region between the pericardium and the posterior rib surface. The lateral extensions of the expansible structure are opened along a radial path between the posterior rib surface and the pericardium. The opened lateral extensions are engaged against the pericardium to periodically compress the heart. The laterally oriented expansible structure may be first introduced by bluntly dissecting at least part of an intercostal space prior to advancing the laterally oriented expansible structure. Optionally, the laterally oriented expansible structure may be introduced by sharply dissecting at least part of an intercostal space prior to advancing the laterally oriented expansible structure. Typically, the sharply dissecting step is carried out by advancing a cutting tip coupled to the laterally oriented expansible structure through intercostal tissue, wherein the lateral oriented expansible structure engages at least one rib after the cutting tip dissects tissue between adjacent ribs but before the cutting tip enters a thoracic cavity. The advanced cutting tip may then be retracted prior to advancing the laterally oriented expansible structure.

The lateral extensions may be opened, in a clockwise or counter-clockwise direction, in a fan-like manner by interlocking means on the lateral extensions. The opened lateral extensions may engage the pericardium by pushing or reciprocating a handle attached to the laterally oriented expansible structure. Additionally, a flexible sheet may be unfurled as the lateral extensions are opened. Alternatively, an inflatable bladder may be attached to some of the lateral extensions and be inflated as the lateral extensions are deployed and/or to effect deployment of the lateral extensions.

In another aspect of the method of the present invention, cardiac compression may be performed by providing a cardiac compression device comprising a handle and a laterally oriented expansible intercostal access structure. The handle is positioned generally parallel to a patient's chest so that the access structure is directed at an intercostal location over the heart. The access structure is then penetrated through the intercostal location until further penetration is prevented when the handle engages the chest. The handle is raised to pass the access structure beneath the ribs without injuring the heart. The access structure is then expanded after the handle has been raised and the handle reciprocated to compress the heart. The access structure will typically be directed at a location between the fourth and sixth ribs. The access structure may comprise a plurality of lateral extensions, which are spread in a scissor-like manner by closing separate shafts of the handle, or are rotated about a handle axis to open in a fan-like manner.

### BRIEF DESCRIPTION OF THE DRAWINGS

FIG. 1 is a perspective view of a cardiac massage device constructed in accordance with the principles of the present invention.

FIG. 2 illustrates a collapsed configuration of the device of FIG. 1.

FIGS. 3A-3B illustrate expanded configurations of the device of FIG. 1.

FIG. 4 illustrates a curved lateral extension which may be employed in the device of FIG. 1.

FIG. 5 illustrates an interlocking mechanism which may be employed in the device of FIG. 1.

FIGS. 6A and 6B illustrate a cardiac massage device according to the present invention with a flexible sheet.

FIG. 7 illustrates a cardiac massage device according to the present invention with an inflatable bladder.

FIGS. 8A and 8B illustrate a cardiac massage device according to the present invention having cutting means.

FIG. 9 is a cross-sectional view illustrating the heart beneath a patient's rib cage.

FIGS. 10A-10D illustrate a method according to the present invention employing the cardiac massage device of FIG. 1.

### DESCRIPTION OF THE SPECIFIC EMBODIMENTS

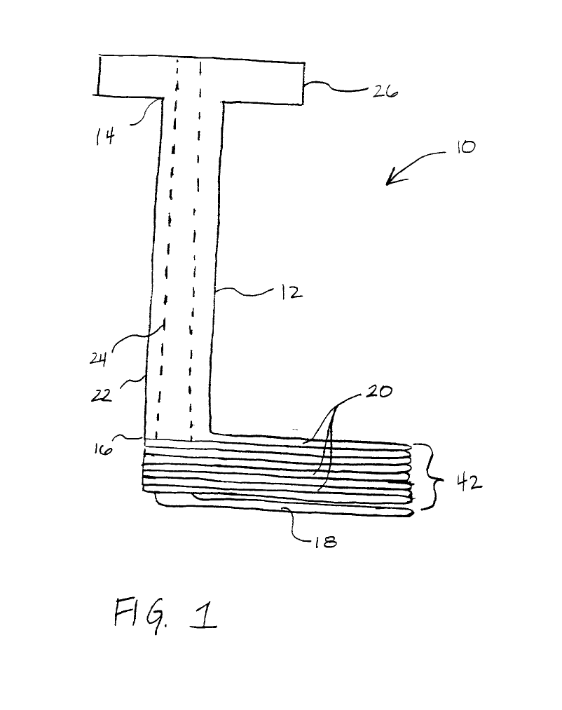

Referring now to FIG. 1, an exemplary device 10 constructed in accordance with the principles of the present invention comprises a support 12, having a proximal end 14 and a distal end 16, and a laterally oriented expansible structure 18 attached to the distal end 16 of the support 12. The laterally oriented expansible structure 18 comprises a plurality of lateral extensions 20 being collapsible to a generally L shaped configuration and expandable along a radial path to define a surface which non-traumatically engages a pericardium to compress the heart. It will be appreciated that the following depictions are for illustration purposes only and does not necessarily reflect the actual shape, size, or dimensions of the cardiac compression device 10. This applies to all depictions hereinafter.

The support 12 may be any assembly, structure, system, or other mechanical framework which is suitable for positioning and manipulating the laterally oriented expansible structure 18 so that it can engage and compress the heart. Most simply, the support 12 could be a simple handle or shaft made of plastic, metal, rubber, or like materials. In an exemplary embodiment, the support 12 comprises at least two separate shafts 22, 24. The shafts 22, 24 may be parallel and rotatably affixed relative to each other so that the lateral extensions 20 can be expanded in a fan-like manner by counter rotating shafts 22, 24. The device 10 may further comprise a rotatable knob 26 at the proximal end 14 of the support 12 for expanding the lateral extensions 20. The knob 26 and the support 12 will usually be integrally formed, as illustrated in FIG. 1. Additionally, an indicator may be placed on the proximal end 14 of the support 12 or outside the patient for indicating the relative position of the lateral extensions 20.

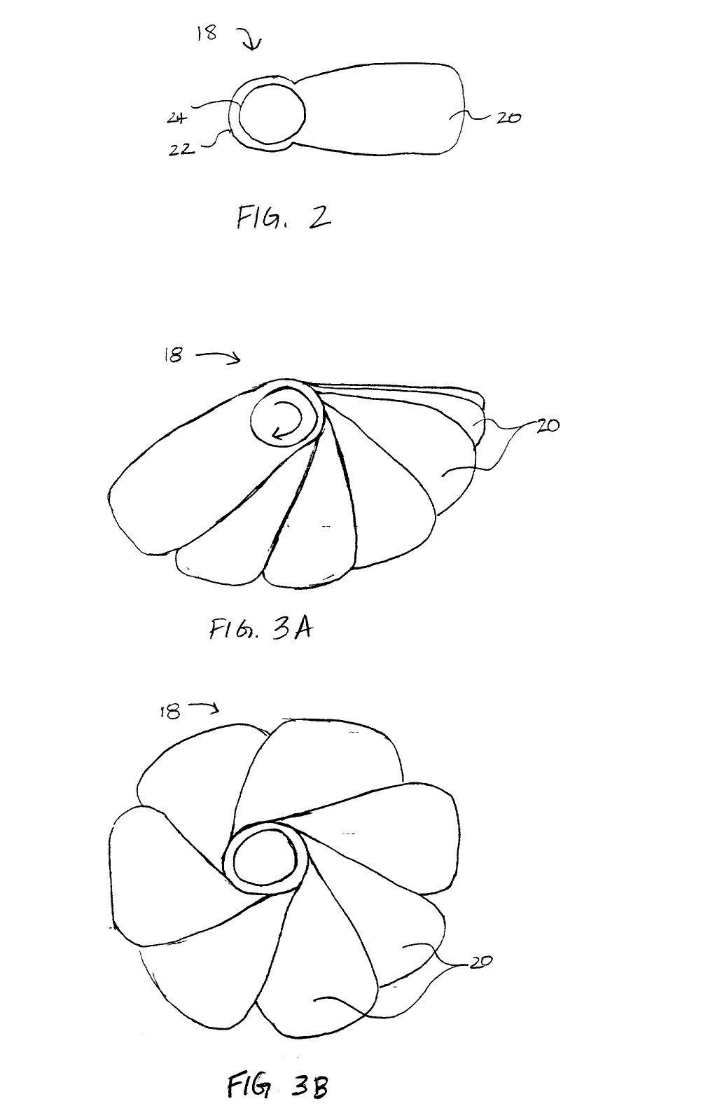

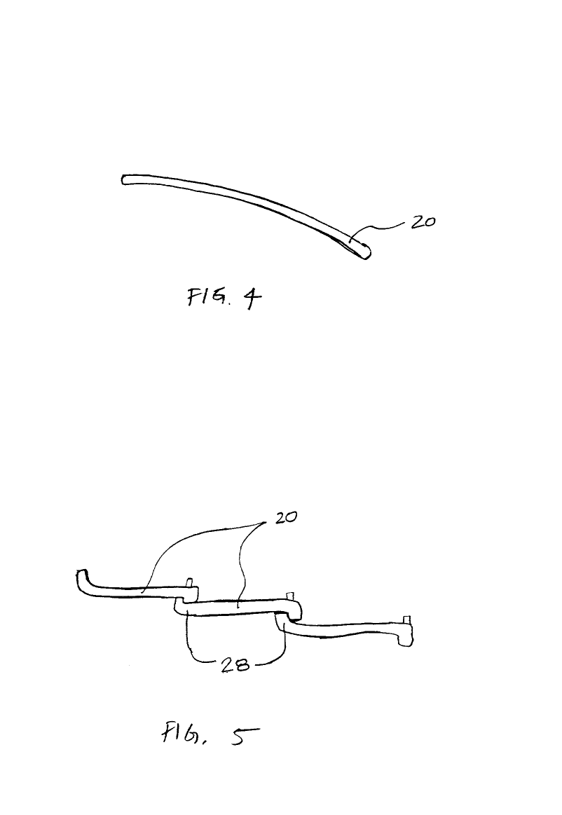

Referring now to FIGS. 2, 3A, and 3B, the laterally oriented expansible structure 18 comprises a plurality of lateral extensions 20, typically about three to twelve lateral extensions 20. Each lateral extension 20 will have a length from 1.5 cm to 5.0 cm and a width from 0.5 cm to 3.0 cm. The lateral extensions 20 will be sufficiently rigid to compress the heart and to impart an enhanced tactile feel to a user of the cardiac massage device, the lateral extensions 20 typically being composed of metal, plastic, composite (e.g., epoxy, fiberglass), or like materials. As discussed above, the laterally oriented expansible structure 18 facilitates simple deployment and expansion in a relatively shallow space between the posterior rib cage and the pericardium. In particular, an important advantage of the present invention is that the fan-like expansion of the lateral extensions 20 enhance adhesion dissection between the pericardium and the rib cage to allow for simple deployment.

The lateral extensions 20 may be collapsed to a generally L shaped configuration which occupies less than one third of a of a fully expanded radial path of 360°, as shown in FIG. 2. Typically, the lateral extensions 20 will be collapsed during delivery of the laterally oriented expansible structure 18 through an intercostal space to a region over a pericardium. Upon deployment, the lateral extensions 20 may be expanded along a radial path of at least 90° to define a surface which engages the heart, as shown in FIGS. 3A and 3B. Usually, the surface in a fully expanded radial path will be generally circular or slightly oval with a diameter or average diameter in the range from 3 cm to 10 cm, as depicted in FIG. 3B. Alternatively, the laterally oriented expansible structure 18 may form a non-symmetric surface, as depicted in FIG. 3A, which may be better oriented to avoid and/or minimize risk to the pericardium and/or to other intrathoracic organs.

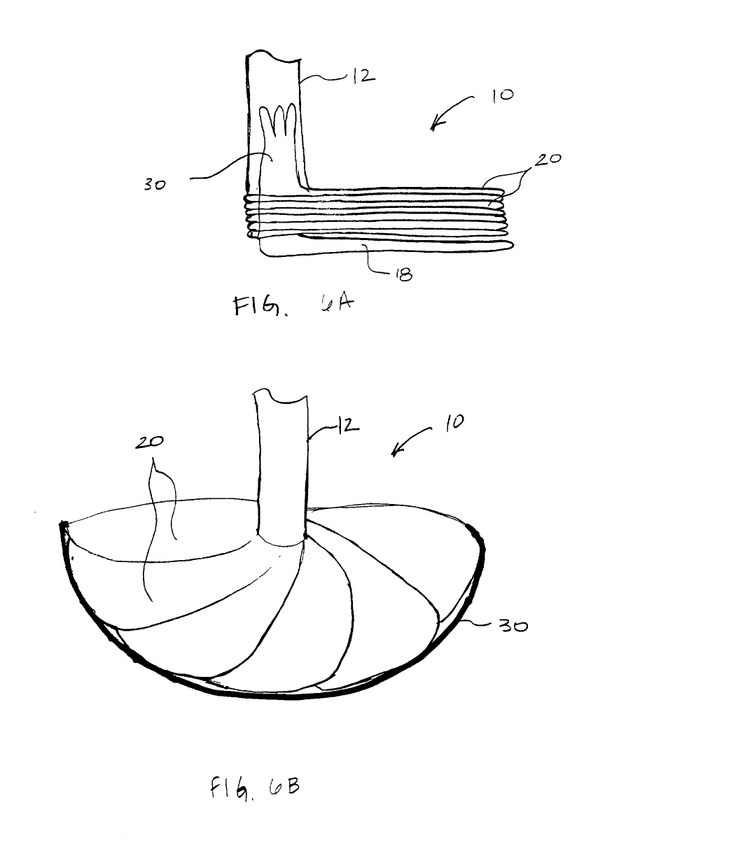

Referring now to FIG. 4, some of the lateral extensions 20 may be curved or slightly concave to generally conform to an exterior surface of the pericardium and heart. Optionally, at least some of the lateral extensions 20 may have conductive surfaces so as to allow for defibrillation, monitoring, pacing, and the like of the contacting heart surface. As shown in FIG. 5, the lateral extensions 20 will have interlocking means 28, such as a lip, pin/slot, or like mechanism, with other lateral extensions 20 for retracting and/or expanding the laterally oriented structure 18 in a fan-like manner. Such interlocking means 28 prevents over deployment and expansion of the lateral extensions 20.

Referring now to FIGS. 6A and 6B, at least some of the lateral extensions 20 may carry a flexible sheet 30 which is deployed to span across the lateral extensions 20 as the lateral extensions are radially expanded, as shown in FIG. 6B. The flexible sheet 30 may be any of the materials or in any of the forms described above, and will serve as an interface surface for engaging the pericardium as the devices 10 of the present invention are used for direct cardiac massage.

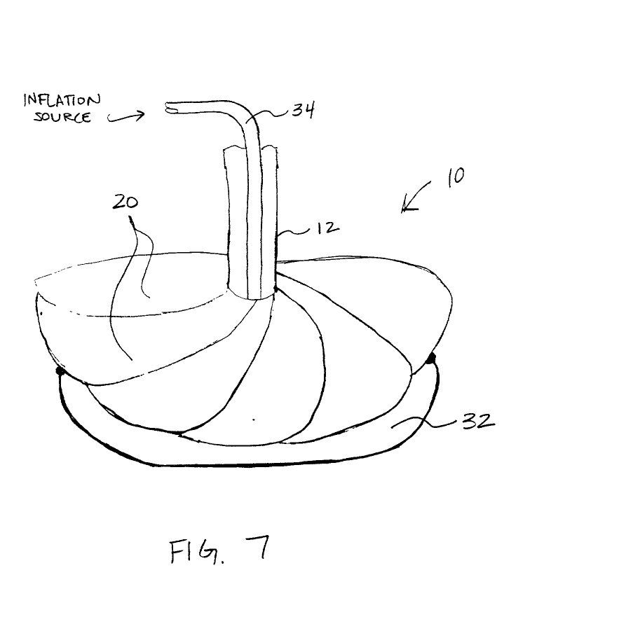

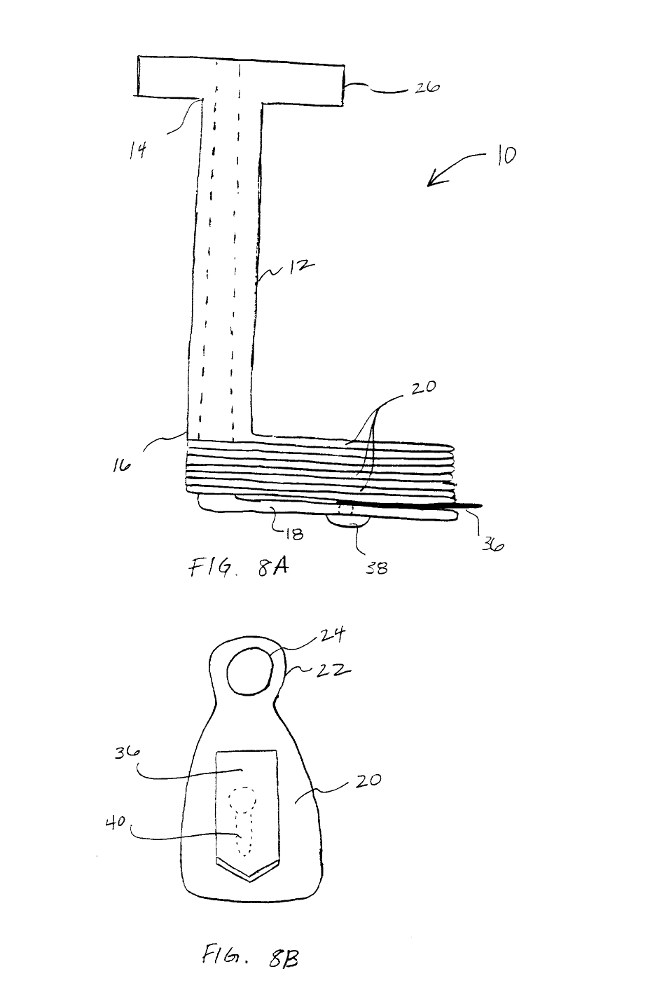

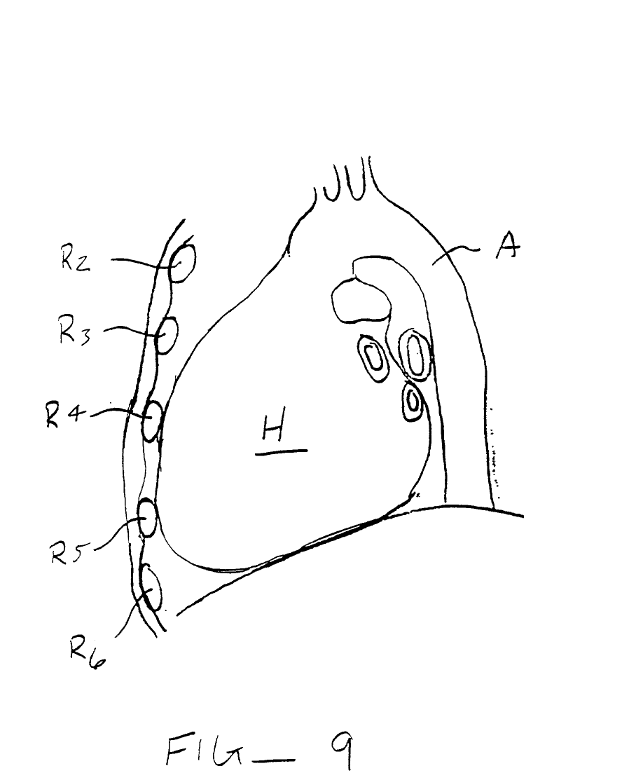

Referring now to FIG. 7, the cardiac massage may optionally be provided with an inflatable bladder 32 which is attached to at least to some of the lateral extensions 20. The inflatable bladder 32 will have an inflation tube 34 extending proximally outward from the device 10 so that it may be connected to a suitable inflation source, such as a syringe filled with saline, contrast medium, or other suitable inflation medium. Advantageously, the inflatable bladder 32 provides a non-traumatic surface for engaging the heart and protecting the pericardium. Moreover, inflation of bladder 32 can assist in the radial deployment of the lateral extensions 20 since mechanical force can be imparted to expand the lateral extensions 20.

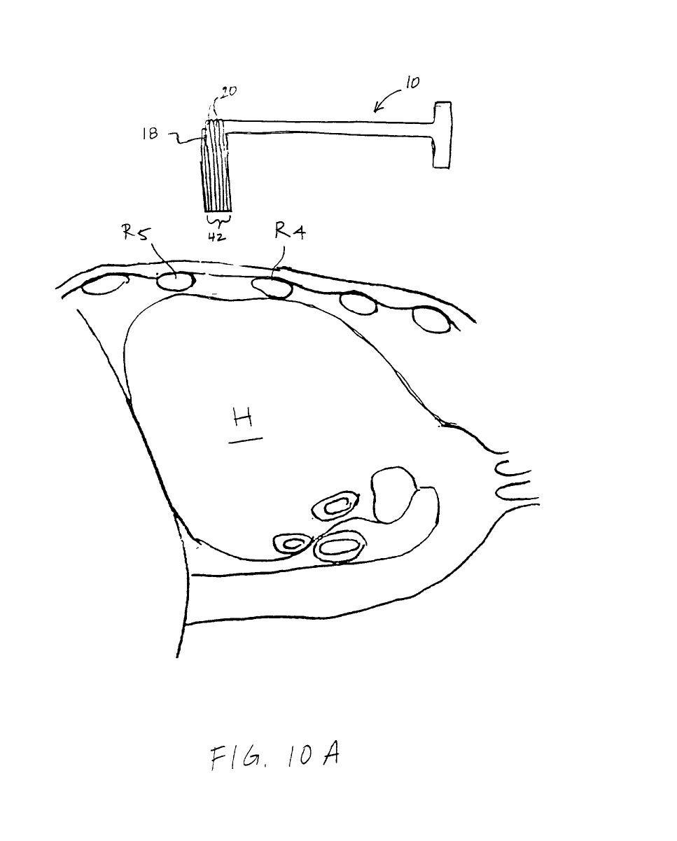

Referring now to FIG. 8A and 8B, a cardiac massage device 10′ of the present invention may have cutting means 36 to facilitate introduction of the laterally oriented expansible structure 18 into the intercostal space for direct cardiac compression. The cutting means 36 may comprise a cutting tip, such as a blade or trocar, coupled to the laterally oriented expansible structure 18 so as to penetrate percutaneously through intercostal tissue between adjacent ribs to a thoracic cavity over a heart. Specifically, the cutting tip 36 coupled to the lateral extension 20 may be advancable and retractable by a button or notch 38 that slides along slot 40. In this embodiment, the collapsed lateral extensions 20 penetrate tissue, engage at least one anterior surface of a rib, and stop advancement of the cutting tip 36 into the thoracic cavity (typically the cutting tip 36 stopping within ±5 mm of the cavity, usually within ±3 mm of the cavity). As such, rapid sharp dissection with the cutting tip 36 can be safely implemented without fear of blind advancement and/or accidentally puncturing intrathoracic organs. The cutting tip 36 may have a cutting edge that is triangular, serrated, curved, or a combination thereof. In particular, the cutting tip 36 will typically have a maximum length of 10 mm or less, preferably a maximum length of 5 mm or less, from a distal perimeter 42 of the collapsed lateral extensions 20. Optionally, the expansible structure 18 may comprise a tissue-dissecting tip, such as cutting means 36, and a preselected length to permit intercostal penetration, with the handle 12 oriented to act as a stop to prevent penetration of an underlying heart. The handle 12 and access structure 18 being configured so that the handle 12 may be raised to pass the access structure 18 beneath the ribs to overlie the heart in a position to permit direct cardiac compression by reciprocating the handle. Alternatively, a distal perimeter 42 of the collapsed lateral extensions 20 may act as a blunt dissecting member 42 to permit intercostal penetration between adjacent ribs to a thoracic cavity over a heart (FIG. 1).

Referring to FIG. 9, the patient's heart H is shown in cross-section between ribs Rₙ where n indicates the rib number. The aorta A is also shown extending from the top of the heart.

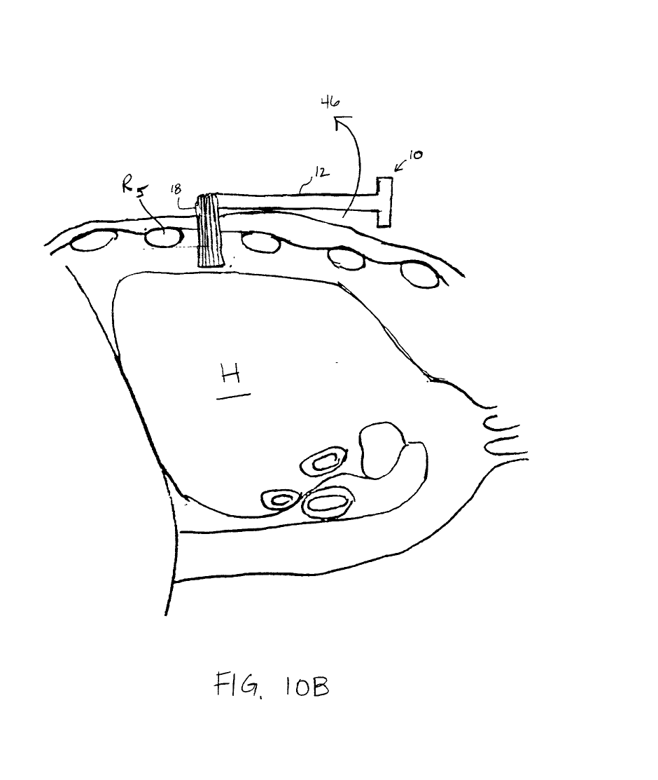

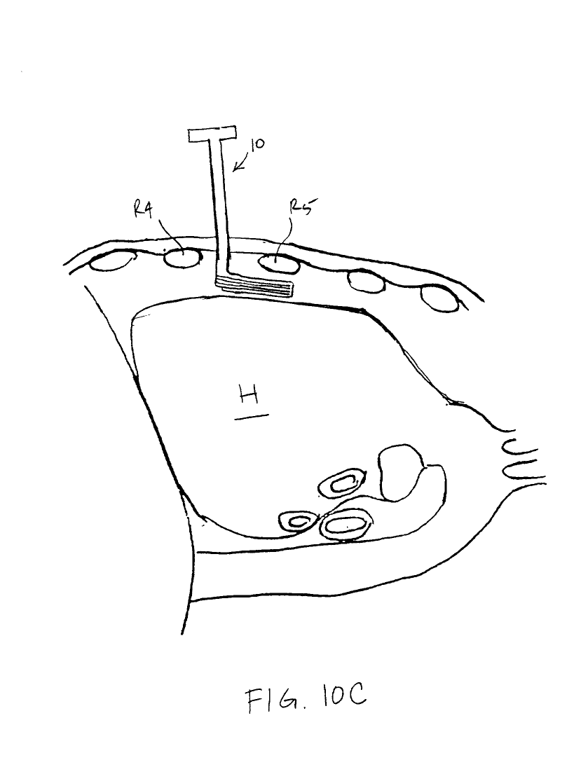

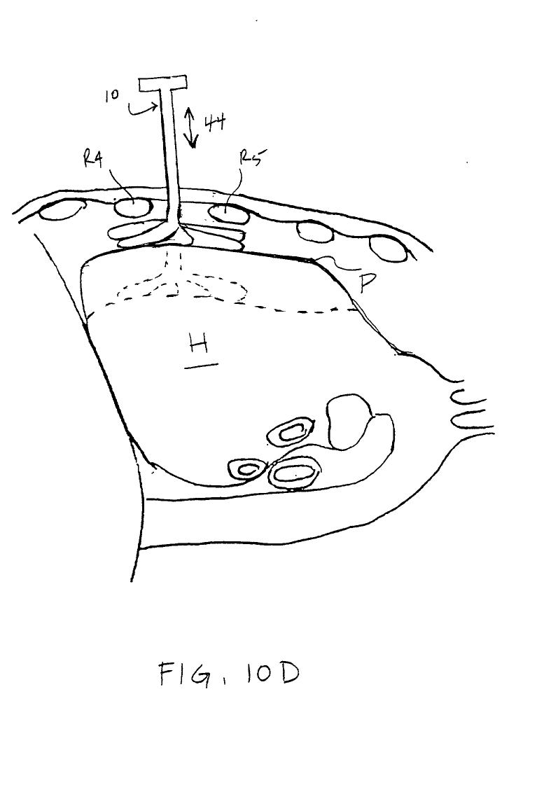

Referring now to FIGS. 10A-10D, a first exemplary method for performing cardiac massage with the device of FIG. 1 will be described. An expansible structure 18 comprising a plurality of lateral extensions 20 is advanced in a posterior direction through an intercostal space between R₄ and R₅ to a region over a pericardium, as shown in FIG. 10A. intercostal space between R₄ and R₅ to a region over a pericardium, as shown in FIG. 10A. The structure 18 is turned so that the lateral extensions 20 lie between a posterior rib surface and the pericardium, as shown in FIGS. 10B and 10C. The lateral extensions 20 are then opened along a radial path of at least 90° between a posterior rib surface and the pericardium P, as shown in FIG. 10D. The opened lateral extensions 20 are engaged against the pericardium P, and the device 10 as a whole may be reciprocated in direction 44 to periodically compress the heart H, as shown in broken line. Such reciprocation will preferably be performed at a rate from 30 cycles/minute to 120 cycles/minute, preferably between 60 cycles/minute to 100 cycles/minute either manually or employing a powered drive (not shown).

The device 10 may be first introduced by bluntly dissecting at least part of an intercostal space with blunt member 42 prior to advancing the laterally oriented expansible structure 18, as shown in FIGS. 10A and 10B. Alternatively, the device 10 may be introduced by sharply dissecting at least part of an intercostal space with cutting means 36 prior to advancing the laterally oriented expansible structure 18 (not shown). Advancement of the cardiac compression device 10 may be carried out by positioning the handle 12 generally parallel to a patient's chest so that the access structure 18 is directed at an intercostal location over the heart H, as shown in FIG. 10A. The access structure 18 is then penetrated through an intercostal location between R₄ and R₅ until further penetration is prevented when the handle 12 engages the chest, as shown in FIG. 10B. The handle 12 is then raised as depicted by arrow 46 to pass the access structure 18 beneath the ribs without injuring the heart H, as shown in FIG. 10C. The access structure 18 is then expanded after the handle 12 has been raised and the handle 12 reciprocated to compress the heart H, as shown in FIG. 10D.

Although certain preferred embodiments and methods have been disclosed herein, it will be apparent from the foregoing disclosure to those skilled in the art that variations and modifications of such embodiments and methods may be made without departing from the true spirit and scope of the invention. Therefore, the above description should not be taken as limiting the scope of the invention which is defined by the appended claims.

What is claimed is:

1. A cardiac massage device comprising:
a support having a proximal end and a distal end; and
a laterally oriented expansible structure attached to the distal end of the support, said structure comprising a plurality of lateral extensions being collapsible to a generally L shaped configuration and expandable along a radial path to define a surface which non-traumatically engages a pericardium to compress the heart.

2. A device as in claim 1, wherein the lateral extensions are collapsed to less than one third of a fully expanded radial path.

3. A device as in claim 1, wherein the lateral extensions are expanded along a radial path of at least 90°.

4. A device as in claim 1, wherein the laterally oriented expansible structure forms a non-symmetric surface.

5. A device as in claim 1, wherein at least some of the lateral extensions are curved.

6. A device as in claim 1, wherein at least some surfaces of the lateral extensions are conductive.

7. A device as in claim 1, wherein each lateral extension has interlocking means with the other lateral extensions for retracting or expanding the structure.

8. A device as in claim 1, wherein the support comprises at least two separate shafts.

9. A device as in claim 8, wherein the shafts are parallel and rotatably affixed relative to each other so that the lateral extensions can be expanded in a fan-like manner by counter rotating shafts.

10. A device as in claim 1, further comprising an indicator on the proximal end of the support.

11. A device as in claim 1, wherein the surface comprises a flexible sheet attached to at least some of the lateral extensions.

12. A device as in claim 1, wherein the surface comprises a non-elastic sheet attached to at least some of the lateral extensions.

13. A device as in claim 1, wherein the surface comprises an inflatable bladder attached to at least some of the lateral extensions.

14. A device as in claim 1, wherein a distal perimeter of the collapsed lateral extensions acts as a blunt dissecting member to permit intercostal penetration.

15. A device as in claim 1, further comprising a cutting tip coupled to the laterally oriented expansible structure, said cutting tip being adapted to penetrate percutaneously through intercostal tissue between adjacent ribs to a thoracic cavity over a heart wherein the collapsed lateral extensions penetrate tissue, engage at least one rib, and stop advancement of the cutting tip into the thoracic cavity.

16. A cardiac compression device comprising:
a handle; and
an expansible intercostal access structure laterally attached at a distal end of the handle, the structure having a tissue-dissecting tip and a preselected length to permit intercostal penetration with the handle oriented to act as a stop to prevent penetration of an underlying heart, wherein the handle and access structure are configured so that the handle may be raised to pass the access structure beneath the ribs to overlie the heart in a position to permit direct cardiac compression by reciprocating the handle.

17. A device as in claim 16, wherein the tissue-dissecting tip comprises a cutting means.

18. A device as in claim 16, wherein the tissue-dissecting tip comprises a blunt dissecting means.

19. A device as in claim 16, wherein the handle comprises at least two separate shafts, each of which has a lateral extension.

20. A device as in claim 19, wherein the shafts are attached in a scissor-like manner so that the lateral extensions lie together when the shafts are apart and the lateral extensions spread apart as the shafts are drawn together.

21. A device as in claim 19, wherein the shafts are parallel and rotatably affixed relative to each other so that the lateral extensions can be opened in a fan-like manner by counter rotating shafts.

22. A method for performing cardiac massage, said method comprising:
advancing in a posterior direction an expansible structure comprising a plurality of lateral extensions through an intercostal space to a region over a pericardium;
turning the expansible structure so that the lateral extensions lie between a posterior rib surface and the pericardium;
opening the lateral extensions along a radial path between the posterior rib surface and the pericardium; and
engaging the opened lateral extensions against the pericardium to periodically compress the heart.

23. A method as in claim 22, further comprising sharply dissecting at least part of an intercostal space prior to advancing the laterally oriented expansible structure.

24. A method as in claim 23, wherein the sharply dissecting step is carried out by advancing a cutting tip coupled to the laterally oriented expansible structure through intercostal tissue, wherein the lateral oriented expansible structure engages at least one rib after the cutting tip dissects tissue between adjacent ribs but before the cutting tip enters a thoracic cavity.

25. A method as in claim 24, further comprising retracting the advanced cutting tip prior to advancing the laterally oriented expansible structure.

26. A method as in claim 22, further comprising bluntly dissecting at least part of an intercostal space prior to advancing the laterally oriented expansible structure.

27. A method as in claim 22, wherein the lateral extensions are opened along a radial path of at least 90°.

28. A method as in claim 22, wherein the lateral extensions are opened in a clockwise direction.

29. A method as in claim 22, wherein the lateral extensions are opened in a counter-clockwise direction.

30. A method as in claim 22, wherein the lateral extensions are opened in a fan-like manner by interlocking means on the lateral extensions.

31. A method as in claim 22, wherein the opened lateral extensions engage the pericardium by pushing on a handle attached to the laterally oriented expansible structure.

32. A method as in claim 22, further comprising unfurling a flexible sheet attached to at least some of the lateral extensions.

33. A method as in claim 22, further comprising inflating a bladder attached to at least some of the lateral extensions.

34. A method as in claim 33, wherein the bladder is inflated while the lateral extensions are being opened.

35. A method as in claim 33, wherein the bladder is inflated after the lateral extensions are opened.

36. A method for performing cardiac compression, said method comprising:
providing a cardiac compression device comprising a handle and a laterally oriented expansible intercostal access structure;
positioning the handle generally parallel to a patient's chest so that the access structure is directed at an intercostal location over the heart;
penetrating the access structure through the intercostal location until further penetration is prevented when the handle engages the chest;
raising the handle to pass the access structure beneath the ribs without injuring the heart;
expanding the access structure after the handle has been raised; and
reciprocating the handle to compress the heart.

37. A method as in claim 36, wherein the access structure is directed at a location between the fourth and sixth ribs.

38. A method as in claim 36, wherein the access structure comprises a plurality of lateral extensions which are spread in a scissor-like manner by closing separate shafts of the handle.

39. A method as in claim 36, wherein the access structure comprises a plurality of lateral extensions which are rotated about a handle axis to open in a fan-like manner.
